(19) United States
(12) Patent Application Publication
(10) Pub. No.: US 2016/0129721 A1
(43) Pub. Date: May 12, 2016

(54) CLIP CONSTRUCTION FOR PAPER SHEETS AND THE LIKE

(71) Applicant: BALMA, CAPODURI & C.S.P.A., VOGHERA (PV) (IT)

(72) Inventor: Aldo BALMA, VOGHERA (PV) (IT)

(21) Appl. No.: 14/702,746

(22) Filed: May 3, 2015

(30) Foreign Application Priority Data
Nov. 11, 2014 (IT) MI2014U000346

(51) Int. Cl. B42F 1/08

(52) U.S. Cl. CPC B42F 1/08

(57) ABSTRACT

A clip construction, particularly for paper sheets and the like, comprises a wire element, which is so bent as to form two wire loops, the wire loops being substantially overlapped onto one another, and each wire loop having a substantially triangular configuration, each wire loop being formed by a shared wire length and two further wire lengths of which at least one is slanted through an angle less than 90° with respect to the shared wire length.

### BACKGROUND OF THE INVENTION

The present invention relates to a clip construction, particularly for paper sheets and the like.

As is known, a conventional “clip” construction is a clamping arrangement formed by a metal wire, which is so bent as to define two resilient loops adapted to restrain paper sheets in a non-permanent manner.

In a regular sheet clip, each of said two clip loops is constituted by two wire parallel portions, merging in a curved part.

A conventional clip has a substantially oval shape, including two long parallel rectilinear sides joined by two end bent portions, thereby satisfactorily clamping a number of sheets while preventing said sheets from undesirably disengaging the clip.

It is frequently desirable to leaf through a cover or sheet assembly, in which the individual sheets are clamped by a clamping clip, without removing the latter, but leaving said clip at the upper left corner of the cover.

In such a position, the clip will allow the sheets to be upward displaced one at a time.

However, the longitudinal extension of the clip prevents each sheet from being fully “opened”, and accordingly does not allow to clearly see a cover underlying sheet.

For aiding the sheet leafing, it is possible to leftward move the clip and possibly to incline it by rotating leftward its bottom end portion.

On the other hand, such an operation greatly reduces the gripping force of the clip.

In fact, by moving away the sheet and opening the latter toward the cover top edge, the clip is undesirably pushed away thereby loosing its gripping and being caused to “jump” away.

### SUMMARY OF THE INVENTION

Thus, the aim of the present invention is to provide a novel clip construction which, while providing a tight gripping, allows a cover to be leafed through in a much easier manner than by using conventional clips.

Within the scope of the above mentioned aim, a main object of the invention is to provide such a clip construction which may be easily and quickly made of elements and materials easily available on the market and which, moreover, is very competitive from a mere economic standpoint.

Yet another object of the present invention is to provide such a clip construction which, owing to its specifically designed structural features, is very reliable and safe in operation.

According to one aspect of the present invention, the above mentioned aim and objects, as well as yet other objects, which will become more apparent hereinafter, are achieved by a clip construction particularly for paper sheets and the like, characterized in that said clip construction comprises a wire element so bent as to form two wire loop being substantially overlapped onto one another and each having a substantially triangular shape.

Said wire loops are formed by a shared wire length and two further wire lengths of which at least one is slanted through an angle less than 90° with respect to the shared wire length.

### BRIEF DESCRIPTION OF THE DRAWINGS

Further characteristics and advantages of the present invention will become more apparent hereinafter from the following disclosure of a preferred, though not exclusive, embodiment of the invention which is illustrated, by way of an indicative but not limitative example, in the accompanying drawings, where:

FIG. 1 is a top plan view of the clip construction according to the present invention;

FIG. 2 is a further top plan view of a sheet assembly, comprising a plurality of sheets clamped by the clip construction according to the present invention; and

FIG. 3 shows the clip construction in an operating condition thereof.

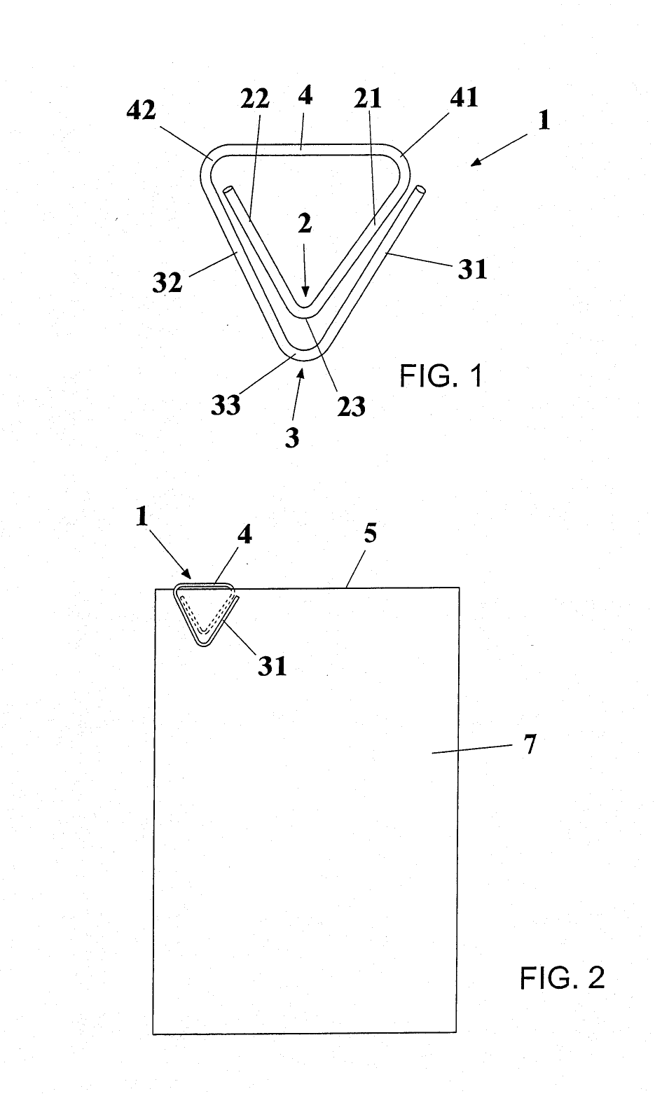

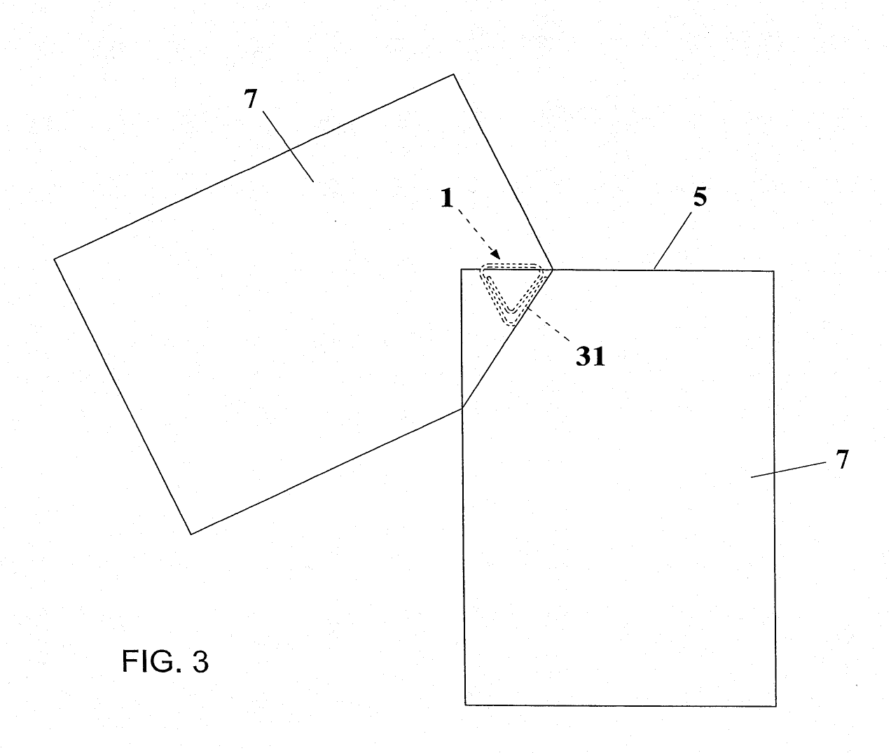

### DESCRIPTION OF THE PREFERRED EMBODIMENTS

With reference to the number references of the above mentioned figures, the clip construction, specifically designed for paper sheets and the like, according to the present invention, which has been generally indicated by the reference number 1, comprises a wire element 2 so bent as to form two wire loops, being indicated by the reference numbers 2 and 3, respectively, and substantially overlapping onto one another.

According to the present invention, each said wire loop has a substantially triangular shape and is formed by a shared wire length 4 and two further wire lengths of which at least one is slanted through an angle less than 90° with respect to the shared wire length.

More specifically, the first wire loop comprises a first slanted or inclined wire length 21, merging with the shared wire length 4 through a curved wire portion 41, and a second wire length 22, merging with the first slanted wire portion 21 through a further curved wire portion 23.

The second wire loop 3 comprises a second wire length 32, merging with the shared wire length 4 through a curved wire length portion 42, as well as a first slanted wire length 31, merging with the second wire length 32 through a further curved wire portion 33.

According the present invention, it is sufficient to slant the first wire lengths 21 and 31 of each said wire loop through an angle less than 90° with respect to the shared wire length 4, whereas the second wire length 22 and 32 may also be arranged at an angle of 90° with respect to the first shared wire length 4, to form, for example, a right-angled triangle.

The clip construction has a substantially isosceles triangle configuration, more preferably an equilateral triangle configuration, as in the shown example.

The wire is preferably made of a metal material, but it should be apparent that any other materials having suitable strength and resilient characteristics may be herein used.

In operation, the clip construction according to the present invention is substantially used as conventional clip, by arranging the two clip loops so as to encompass the cover sheets 7, while arranging the shared wire length 4 at the top edges of the sheets 7.

As one wishes to leaf through the cover or sheet assembly, it is sufficient to raise the top sheet 7 by bending it at the first length 31 of the wire loop 3 which, in the case shown here, will be arranged on the top of the cover.

Thus, an inclination of the first length of the wire loop allows to easily bent or fold the sheet, without upward pushing the clip construction, thereby preventing said clip construction from undesirably disengaging and making the sheets loose.

It has been found that the invention fully achieves the intended aim and objects.

In fact, the invention has provided a clip construction, of the type including a metal wire so bent as to form two wire loops, said two wire loops including at least an inclined wire loop side or length, that is that facing the inner part of the sheets, thereby, by opening and raising a sheet, said sheet may be easily folded to facilitate a read-out operation, while preventing any force susceptible to disengage the clip construction from being applied.

In practicing the invention, the materials used, as well as the contingent size and shapes, may be any, depending on requirements.

1. A clip construction, for paper sheets and the like, characterized in that said clip construction comprises a wire element, which is so bent as to form two wire loops, said wire loops being substantially overlapped onto one another, and each said wire loop having a substantially triangular configuration, each said wire loop being formed by a shared wire length and two further wire lengths of which at least one is slanted through an angle less than 90° with respect to said shared wire length.

2. A clip construction, according to claim 1, characterized in that said first wire loop comprises a first slanted or inclined wire length, merging with the shared wire length through a curved wire portion, and a second wire length, merging with the first slanted wire length through a further curved wire portion.

3. A clip construction, according to claim 1, characterized in that said second wire loop comprises a second wire length, merging with the shared wire length through a curved wire length portion, as well as a first slanted wire length, merging with the second wire length through a further curved wire portion.

4. A clip construction, according to claim characterized in that at least the first wire length is slanted through an angle less than 90° with respect to the shared wire length.

5. A clip construction, according to claim 1, characterized in that said clip construction has substantially isosceles triangle configuration.

6. A clip construction, according to claim 1, characterized in that said clip construction has substantially equilateral triangle configuration.

7. A clip construction, according to claim 1, characterized in that said clip construction has substantially right-angled triangle configuration.

8. A clip construction, according to claim 1, characterized in that said wire element is a metal wire element.
